(19) United States
(12) Patent Application Publication
(10) Pub. No.: US 2014/0009359 A1
(43) Pub. Date: Jan. 9, 2014

(54) WIDEBAND MONOPOLE ANTENNA AND ELECTRONIC DEVICE

(71) Applicant: ARCADYAN TECHNOLOGY CORPORATION, Hsinchu (TW)

(72) Inventors: CHIH-YUNG HUANG, TAICHUNG CITY (TW); KUO-CHANG LO, MIAOLI COUNTY (TW); JIAN-JHIH DU, TAIPEI CITY (TW)

(73) Assignee: ARCADYAN TECHNOLOGY CORPORATION, HSINCHU (TW)

(21) Appl. No.: 13/668,281

(22) Filed: Nov. 4, 2012

(30) Foreign Application Priority Data
Jul. 4, 2012 (TW) 101124127

(51) Int. Cl. H01Q 1/38; H01Q 1/48

(52) U.S. Cl. 343/846; 343/700 MS

(57) ABSTRACT

The present invention discloses an electronic device including a signal transmission module and a wideband monopole antenna. A feeding portion of the antenna is coupled to the signal transmission module through a feeding cable. A first radiating portion and a second radiating portion of the antenna are respectively coupled to the feeding portion, wherein the feeding portion, the first radiating portion, and a signal ground portion define a first slot, while the second radiating portion and the signal ground portion define a second slot. In the first slot, the spacing between the first radiating portion and the signal ground portion is not less than a first distance. In the second slot, the spacing between the second radiating portion and the signal ground portion is not less than a second distance. Thus, the voltage standing wave ratio of the antenna within a frequency band is less than a threshold.

### BACKGROUND

1. Technical Field

The present disclosure relates to a wideband monopole antenna and electronic device in particular, to a wideband monopole antenna planarly disposed on a circuit board substrate and an electronic device thereof.

2. Description of Related Art

As wireless transmission technology progresses, industries have defined various transmission standards for various systems. For instance, the primary operating frequency range for the Universal Mobile Telecommunication System (UMTS) is from 1920 MHz to 2170 MHz. For WiFi system under IEEE 802.11 standard, in particular the primary operating frequency range of IEEE 802.11bg standard is from 2.40 GHz to 2.50 GHz, the primary operating frequency range of Long Term Evaluation (LTE) standard is from 1.71 GHz to 2.70 GHz, and the primary operating frequency range of IEEE 802.11a standard is from 5.51 GHz to 5.85 GHz. Additionally, according to the Ultra Wide Band (UWB) system adopting IEEE 802.15.3a standard, the primary operating frequency range is from 3.1 GHz to 4.8 GHz.

The current design trend for electronic device is geared toward light-weighed, miniaturization and compact designs. Hence, in order to effectively reduce the volume of antenna, the industry integrates the antenna inside the electronic device, increases the demands for planar and hidden antenna. However, the operating frequency band for conventional planar and hidden antenna is relatively narrow and cannot be used for different systems at same time thereby limits the applications of the associated electronic device. For example, in practice, for receiving wireless signal having lower frequency, an exposure antenna shall be used for better reception quality. But this type of antenna design certainly does not satisfy modern electronic design concept. Henceforth, how to design an antenna that can operate in a wider range while capable of being hidden inside the electronic device become the most urgent issues to be resolved.

### SUMMARY

Accordingly, an exemplary embodiment of the present disclosure provides a wideband monopole antenna which can be planarly placed on the surface of a substrate. The wideband monopole antenna can further have wider operating frequency band through configuring the width of the slots between the radiating portions and the signal ground portion.

An exemplary embodiment of the present disclosure provides a wideband monopole antenna which forms on a first surface of a circuit board substrate with the first surface at least having a signal ground portion. The wideband monopole antenna includes a feeding portion, a first radiating portion, and a second radiating portion. The feeding portion is coupled to a feeding cable. The feeding portion has a first side and a corresponding second side. The first radiating portion is coupled to the feeding portion and the first radiating portion at least has a third side. The third side is connected to the first side of the feeding portion such that the first side, the third side, and a fifth side of the signal ground portion collectively define a first slot. The second radiating portion is coupled to the feeding portion. The second radiating portion at least has a fourth side with the fourth side connects to the second side of the feeding portion. A portion of the fourth side and a sixth side of the signal ground portion collectively define a second slot therebetween. The fifth side extends along a first direction while the sixth side extends along a second direction, wherein the first direction and the second direction extend toward nonparallel directions. The third side of the first radiating portion and the fifth side of the signal ground portion are correspondingly formed in the first slot with the spacing therebetween being no less than a first distance while a portion of the fourth side of the second radiating portion and the sixth side of the signal ground portion are correspondingly formed in the second slot with the spacing therebetween being no less than a second distance so that the voltage standing wave ratio (VSWR) of the wideband monopole antenna within a frequency band is less than a first threshold.

According to one exemplary embodiment of the present disclosure, the spacing between the third side of the first radiating portion and the fifth side of the signal ground portion in the first slot can be configured to have the VSWR of the first radiating portion within a first frequency band less than a first threshold while the spacing between the fourth side of the second radiating portion and the sixth side of the signal ground portion in the second slot can be configured to have the VSWR of the second radiating portion within a second frequency band less than a first threshold. In which, partial operating frequency of the first frequency band overlaps the second frequency band to have the VSWR of the wideband monopole antenna being less than a first threshold. The center frequency of the first frequency band is higher than the center frequency of the second frequency band.

According to one exemplary embodiment of the present disclosure, at least a portion of the third side is parallel to the fifth side and at least a portion of the fourth side is parallel to the sixth side.

According to one exemplary embodiment of the present disclosure, the first radiating portion includes a first end and a second end in which the first end coupled to the feeding portion extends toward the second end and is gradually enlarged. The second radiating portion includes a third end and a fourth end, with the second radiating portion extends from the third end coupled to the feeding portion toward the fourth end through at least a bending portion. Accordingly, a first gap is form between the first radiating portion and the second radiating portion. The first end of the first radiating portion is adjacent to the third end while the third end of the second radiating portion is adjacent to the forth end.

According to one exemplary embodiment of the present disclosure, the signal ground portion further includes an impedance matching structure. The impedance matching structure is connected to the fifth side and at least having a seventh side in adjacent to the second end of the first radiating portion and the fourth end of the second radiating portion. The wideband monopole antenna is disposed between the sixth side and the seventh side.

According to one exemplary embodiment of the present disclosure, the signal ground portion is used for transmitting a data signal. The wideband monopole antenna at least having a first current path and a second current path. The first current path passing through the feeding portion and the first radiating portion while the second current path passing through the feeding portion and the second radiating portion to have the wideband monopole antenna emitting the data signal through at least the first current path or the second current path. The length of the first current path may be shorter than the second current path.

Additionally, an exemplary embodiment of the present disclosure further provides an electronic device having a wideband monopole antenna which can be planarly disposed on the surface of a substrate. The wideband monopole antenna may through configure the slot width between the radiating portion and the signal ground portion broadening the frequency band thereof.

An exemplary embodiment of the present disclosure provides a signal transmission module and a wideband monopole antenna. The signal transmission module is for transmitting an electric signal to the wideband monopole antenna. The wideband monopole antenna is formed on a first surface of a circuit board substrate with the first surface at least having a signal ground portion. The wideband monopole antenna including a feeding portion, a first radiating portion and a second radiating portion. The feeding portion is coupled to the signal transmission module through a feeding cable to receive the electric signal. The two corresponding side of the feeding portion has a first side and a second side. The first radiating portion is coupled to the feeding portion and the first radiating portion at least has a third side. The third side is connected to the first side of the feeding portion such that the first side, the third side, and a fifth side of the signal ground portion collectively define a first slot. The second radiating portion is coupled to the feeding portion and the second radiating portion at least has a fourth side. The fourth side is connected to the second side of the signal ground portion such that a portion of the fourth side and a sixth side of the signal ground portion collectively define a second slot therebetween. The fifth side extends along a first direction while the sixth side extends along a second direction, wherein the first direction and the second direction extend toward nonparallel directions. The third side of the first radiating portion and the fifth side of the signal ground portion are correspondingly formed in the first slot with the spacing therebetween being no less than a first distance while a portion of the fourth side of the second radiating portion and the sixth side of the signal ground portion are correspondingly formed in the second slot with the spacing therebetween being no less than a second distance so that voltage standing wave ratio (VSWR) of the wideband monopole antenna within a frequency band is less than a first threshold.

To sum up, the wideband monopole antenna and the electronic device provided in the present disclosure not only may be planarly disposed on the surface of the circuit board substrate placed inside the electronic device to avoid having the antenna protruded and exposed outside the electronic device. The VSWR of the wideband monopole antenna in a frequency band further can satisfy the industrial standard and requirement through designing the width associated with the first and the second slots.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is an overhead view of a wideband monopole antenna provided in accordance to an exemplary embodiment of the present disclosure.

FIG. 2A is an isometric diagram illustrating a wideband monopole antenna provided in accordance to an exemplary embodiment of the present disclosure.

FIG. 2B is an isometric diagram illustrating another surface of the circuit board substrate provided in accordance to an exemplary embodiment of the present disclosure.

FIG. 3 shows the voltage standing wave ratio (VSWR) response of a wideband monopole antenna provided in accordance to the exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

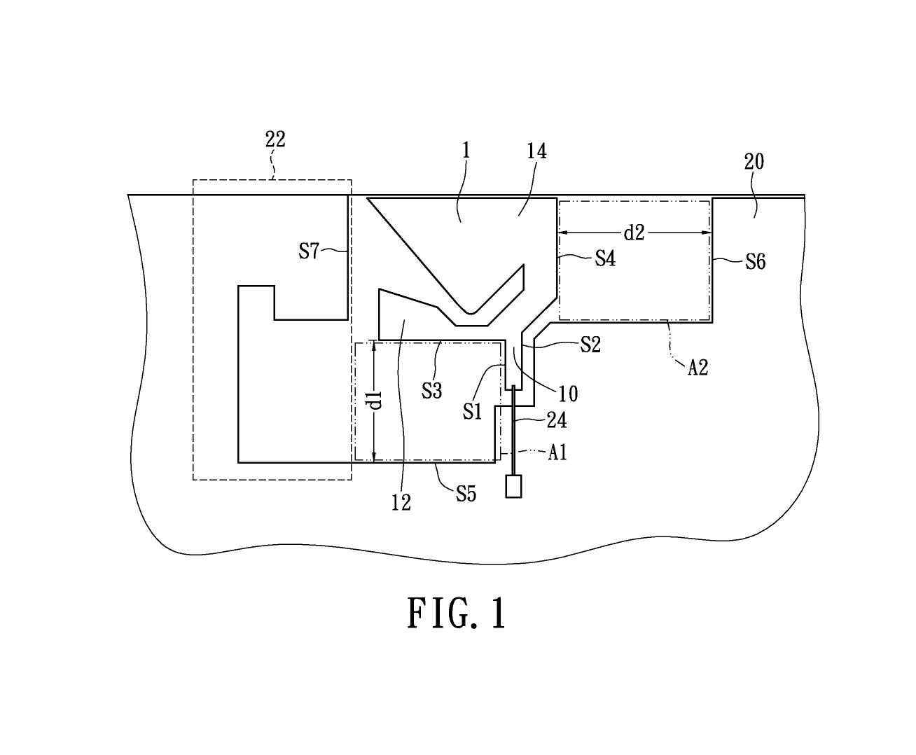

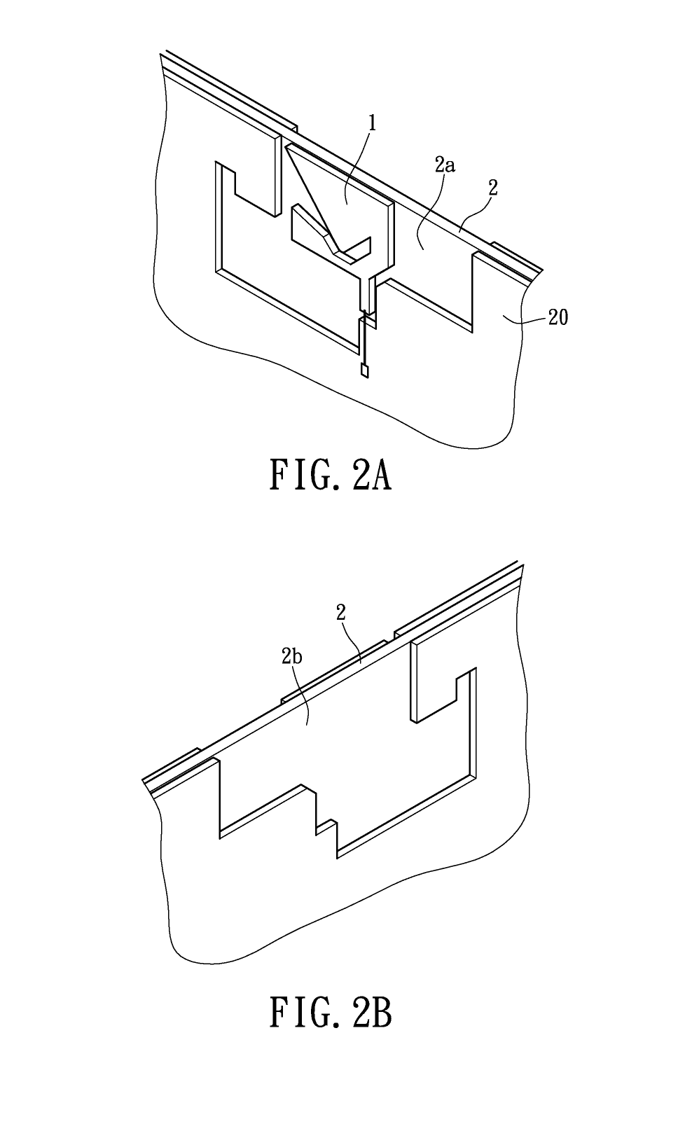

Please refer to FIG. 1 and FIG. 2A at same time. FIG. 1 shows an overhead view illustrating a wideband monopole antenna provided in accordance to an exemplary embodiment of the present disclosure. FIG. 2A shows an isometric diagram illustrating the wideband monopole antenna provided in accordance to the exemplary embodiment of the present disclosure.

As shown, a wideband monopole antenna 1 and a signal ground portion 20 in the instant embodiment are respectively disposed on a surface 2a of a circuit board substrate 2. The wideband monopole antenna 1 includes a feeding portion 10, a first radiating portion 12, and a second radiating portion 14. The wideband monopole antenna 1 is used for emitting the data signal transmitted by the feeding cable 24. In one practical application, the wideband monopole antenna may be an antenna for an electronic device (not shown) to provide the electronic device with the wireless transmission capability. The described electronic device further includes a signal transmission module (not shown) which is coupled to the feeding portion 10 of the wideband monopole antenna 1 through the feeding cable 24. The signal transmission module in practice may generate electric signal to the wideband monopole antenna 1 for the wideband monopole antenna 1 to transmit therefrom wirelessly. Or the wideband monopole antenna 1 may transmit the received electric signal to the signal transmission module of the electronic device via feeding cable 24.

In practice, the circuit board substrate 2 may be a printed circuit board while the wideband monopole antenna 1 and the signal ground portion 20 may be metallic conductors comprising of identical material. Additionally for the wideband monopole antenna 1 to have better transmission quality, the wideband monopole antenna 1 may be positioned at the edge of the circuit board substrate 2 or other appreciated positions on the circuit board substrate 2. The described electronic device many be a handheld communication device, a laptop, a monitor, a smoke detector, a gas detector, or other appropriate electronic equipment and the present disclosure is not limited herein. Those skilled in the art should be able to design an appropriate electronic device for integrating the disclosed wideband monopole antenna 1 therein according to the needs, thus further descriptions are hereby omitted.

Next detailed explanation over the correspondence between the wideband monopole antenna 1 and the signal ground portion 20 is provided in the subsequent paragraph.

The feeding portion 10 is coupled to the feeding cable 24 for receiving the data signal transmitted by the feeding cable 24. The feeding portion 10 at least has a side S1 and a side S2. In practice, since the present disclosure discloses a monopole antenna and those skilled in the art should know that the feeding portion 10 does not directly connect to the signal ground portion 20. The feeding cable 24 may be a coaxial cable coupled to the feeding portion 10. The coaxial cable may have equivalent impedance of 50 ohms and may have an inner conductor and an outer conductor. One end of the inner conductor may electrically connect to the feeding portion 10 while the other end of the inner conductor may couple to a processor (not shown) or other proper circuitry for receiving the data signal. Moreover, the outer conductor may couple to the signal ground portion 20. Of course, the inner conductor and the outer conductor may further include design of insulation layer, however the present disclosure is not limited thereto.

Although the feeding portion 10 shown in FIG. 1 substantially takes form of an elongated strip with the feeding cable coupled to one end thereof, however the present disclosure is not limited thereto. In other words, as long as the wideband monopole antenna 1 is designed to have a place that can be connected to the feeding cable 24, the connected portion is the feeding cable 24. Accordingly, so long as the transmission frequency band of the wideband monopole antenna 1 is not affected, the feeding portion 10 can be designed into other suitable shape and the present disclosure is not limited thereto.

The first radiating portion 12 is coupled to the feeding portion 10 so that the data signal received by the feeding portion 10 can be emitted from the first radiating portion. The first radiating portion 12 at least has a side S3. The side S3 connects to a side S1 of the feeding portion 10. In practice, the head-end of the first radiating portion 12 is connected to the feeding portion 10 and the tail-end of the first radiating portion 12 extends outwardly from the feeding portion 10. The present disclosure does not limit the shape of the first radiating portion 12. For instance, the first radiating proton 12 may take shape of a trapezoid, i.e., the tail-end of the first radiating portion 12 may gradually enlarge. Moreover, the first radiating portion 12 in the instant embodiment is entirely formed on the surface of the circuit board substrate, thus does not have three-dimensional structure.

The side S1 of the feeding portion 10, the side S3 of the first radiating portion 12, and a side S5 of the signal ground portion 20 further collectively define a region i.e., a slot A1. At least a portion of the side S3 of the first radiating portion 12 is parallel to the side S5 of the signal ground portion 20 creating a substantially fixed distance d1 therebetween. The distance d1 may be viewed as the width of the slot A1. Please note that even though the present disclosure does not place any limitations on the length of the side S5 of the signal ground portion 20, however in practice the length of the first radiating portion 12 shall be less than the length of side S5 of the signal ground portion 20 such that the signal ground portion 20 may substantially cover the first radiating portion 12.

Similarly, the second radiating portion 14 is coupled to the feeding portion 10 so that the data signal received by the feeding portion 10 may also emitted from the second radiating portion 14. The second radiating portion 14 at least has a side S4 which is connected to the side S2 of the feeding portion 10. It can be seen from FIG. 1, it is not necessary for the side S4 to be a straight side, instead, the side S4 may have proper bending. In practice, the head-end of the second radiating portion 14 is also coupled to the feeding portion 10 while the tail-end of the second radiating portion 14 extends to the edge of the circuit board substrate 2 through a bending. Even though as shown in FIG. 1, a side of the second radiating portion 14 is justly aligned at the edge of the circuit board substrate 2, however there present disclosure is not limited thereto.

In other words, the present disclosure does not limit the shape of the second radiating portion 14. For instance, the second radiating portion 14 may comprise of a polygon, a trapezoid, a strip, or a snake-like shape having bending(s). The second radiating portion 14 may be entirely formed on the surface 2a of the circuit board substrate 2 thereby does not have three-dimensional structure.

The side S4 of the second radiating portion 14 and the signal ground portion 20 may collectively define another region, i.e. a slot A2. In practice, the slot A2 may substantially be a rectangular region. The boundary of the slot A2 not only includes the second radiating portion 14 and the signal ground portion 20 but also includes the edge of the circuit board substrate 2. That is the second radiating portion 14 is aligned nearing the edge of the circuit board substrate 2 while the first radiating portion 12 is away from the edge as it has being arranged close to the center of the circuit board substrate 2.

Specifically, at least a portion of side S4 is parallel to the side S6 of the signal ground portion 20 creating a substantially fixed distance d2 therebetween. The distance d2 may be views as the width of the slot A2. Please note that even though the present disclosure does not place any limitations on the length of the side S6 of the signal ground portion 20, however in practice the length of the side S6 of the first radiating portion 12 shall be greater than or equal to the nearby axial length of the second radiating portion 14 such that the signal ground portion 20 may substantially cover the second radiating portion 14.

The wideband monopole antenna 1 in practice may be an integrally formed structure, the present disclosure therefore only defines the outline shape of the wideband monopole antenna 1 and does not place limitations on the actual boundary among the feeding portion 10, the first radiating portion 12, and the second radiating portion 14 of the wideband monopole antenna 1.

From data transmission perspective, the wideband monopole antenna 1 at least has a first current path and the second current path enabling the wideband monopole antenna 1 emitting the data signal. The first current path defines a path for which current is distributed to the tail-end of the first radiating portion 12 through the feeding portion 10. The second current path defines a path for which current is distributed to o the tail-end of the second radiating portion 14 through the feeding portion 10. Such that the data signal may be emitted at least through the first current path or the second path from the wideband monopole antenna 1.

In practice, the length of the first current path shall be less than the length of the second current path. Such that the first current path may be used for emitting high frequency data signal while the second current path may be used for emitting low frequency data signal. Those skilled in the art shall understand that the first current path is related to the shape of the first radiating portion 12 and the second current path is related to the shape of the second radiating path. According, for the wideband monopole antenna 1 to be usable in UMTS system, WiFi system, UWB system, and WiMAX system, the wideband monopole antenna 1 must maintain relatively good transmission quality over frequency ranges including 1920 MHz˜2170 MHz, 2.40 GHz˜2.50 GHz, 1.71 GHz˜2.70 GHz, 3.1 GHz˜4.8 GHz, and 5.15 GHz˜5.85 GHz.

The wideband monopole antenna 1 disclosed in the instant embodiment may be also applied in the licensed band including but not limited to the US Wireless Communication Services (WCS) frequency range (2.345 GHz˜2.360 GHz), the Multi-point Microwave Distribution System(MMDS) or Multi-channel Multi-point Distribution System frequency range (2.50˜2.69 GHz), or the international Fixed Wireless Access (FWA) frequency range (3.4 GHz˜3.7 GHz). Moreover, the wideband monopole antenna 1 disclosed in the instant embodiment may be also applied in the unlicensed band including but not limited to ISM frequency range (2.4000˜2.4835 GHz), Unlicensed National Information Infrastructure (U-NII) frequency range (5.15 GHz˜5.35 GHz, 5.725 GHz˜5.825 GHz).

Alternatively, the present disclosure does not limit the applicable frequency bands so long as the lower frequency limit associated with the first radiating portion 12 and the second radiating portion 14 falls within the frequency band ranging from 1.7 GHz to 2 GHz while the upper frequency limit associated with the first radiating portion 12 and the second radiating portion 14 falls within the frequency band ranging from 5.8 GHz to 6 GHz. Thus, those skilled in the art may flexibly design the shapes for the first radiating portion 12 and the second radiating portion 14 according to the application needs.

Please refer again to FIG. 1, the signal ground portion 20 further includes a impedance matching structure 22 which is adapted for improving the signal radiation field. It may be noted that the impedance matching structure 22 and the side S5 are interconnected. The impedance matching structure 22 at least has a side S7 in parallel to the side S6. Moreover, the wideband monopole antenna 1 is arranged between the side S6 and the side S7. Accordingly the physical placement of the wideband monopole antenna 1 may be defined.

Please refer to FIG. 2A in conjunction with FIG. 2B for viewing from another side of the circuit board substrate 2. FIG. 2B shows an isometric diagram illustrating another surface of the circuit board substrate 2 provided in accordance to the exemplary embodiment of the present disclosure. As shown in FIG. 2A, the signal ground portion 20 and the edge of the circuit board substrate 2 collectively surround an antenna placement region on the surface 2a. The wideband monopole antenna 1 thus is formed in the described antenna placement region. However, to enhance the radiation field associated data signal emitted by the wideband monopole antenna, a proper design may be implemented on another surface 2b of the circuit board substrate 2b. For instance, the surface 2b of the circuit board substrate 2 has a clearance region arranged thereon. The clearance region is located right behind the antenna placement region.

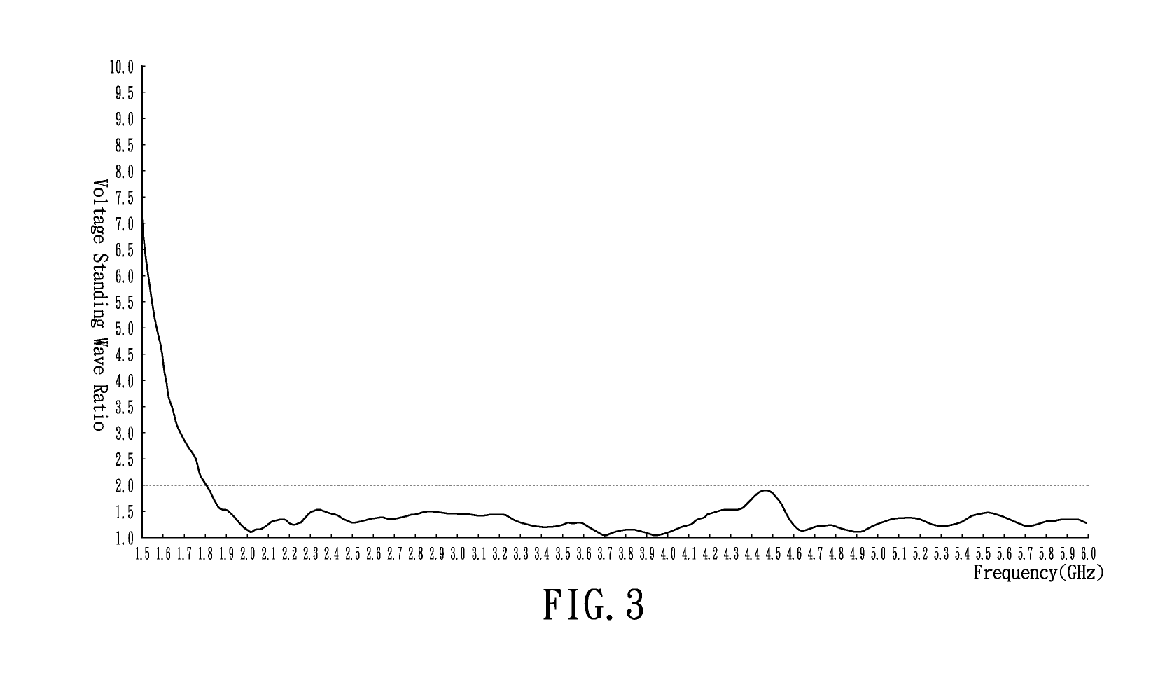

For an actual implementation perspective, please refer to FIG. 3 which illustrates the voltage standing wave ratio (VSWR) response of the wideband monopole antenna provided in accordance to the exemplary embodiment of the present disclosure. When the wideband monopole antenna 1 of the instant embodiment has the slot A1 and the slot A2 designed as 3 mm for an example. As shown in FIG. 3, the voltage standing wave ratio (VSWR) of the wideband monopole antenna 1 within frequency band ranging from 1.8 GHz to 5.8 GHz is less than an industry specified threshold, i.e., 2. However the present disclosure is not limited thereto as the threshold of the VSWR may vary according to the industry requirement.

In summary, the wideband monopole antenna and the electronic device provided in the present disclosure not only may be planarly disposed on the surface of the circuit board substrate placed inside the electronic device to avoid having the antenna protruded and exposed outside the electronic device. The wideband monopole antenna may through respectively design the width of the slot between each of the two radiating portions and the signal ground portion to have the VSWR of the wideband monopole antenna within a frequency band satisfy the industrial standard and requirement.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A wideband monopole antenna, forming on a first surface of a circuit board substrate with the first surface at least having a signal ground portion, the wideband monopole antenna comprising:
a feeding portion, coupled to a feeding cable, the feeding portion at least having a first side and a second side;
a first radiating portion, coupled to the feeding portion, the first radiating portion at least has a third side, the third side being connected to the first side of the feeding portion, the first side, the third side, and the signal ground portion defining a first slot; and
a second radiating portion, coupled to the feeding portion, the second radiating portion at least has a fourth side, the fourth side and the signal ground portion defining a second slot therebetween;
wherein the spacing between the third side of the first radiating portion and a fifth side of the signal ground portion in the first slot is not less than a first distance while the spacing between the fourth side of the second radiating portion and a sixth side of the signal ground portion in the second slot is not less than a second distance so that voltage standing wave ratio (VSWR) of the wideband monopole antenna within a frequency band is less than a first threshold.

2. The wideband monopole antenna according to claim 1, wherein at least a portion of the third side is parallel to the fifth side and at least a portion of the fourth side is parallel to the sixth side.

3. The wideband monopole antenna according to claim 1, wherein the first radiating portion extends outwardly from the feeding portion and is gradually enlarged.

4. The wideband monopole antenna according to claim 1, wherein the signal ground portion further comprises an impedance matching structure, the impedance matching structure being connected to the fifth side and at least having a seventh side being in parallel to the sixth side, the wideband monopole antenna being disposed between the sixth side and the seventh side.

5. The wideband monopole antenna according to claim 1, wherein the signal ground portion is used for transmitting a data signal, the wideband monopole antenna at least having a first current path and a second current path, the first current path passing through the feeding portion and the first radiating portion while the second current path passing through the feeding portion and the second radiating portion to have the wideband monopole antenna emitting the data signal through at least the first current path or the second current path.

6. The wideband monopole antenna according to claim 5, wherein the length of the first current path is less than the length of the second current path.

7. The electronic device, comprising:
a signal transmission module, transmitting an electric signal; and
a wideband monopole antenna, forming on a first surface of a circuit board substrate with the first surface at least having a signal ground portion, the wideband monopole antenna comprising:
a feeding portion, coupled to the signal transmission module through a feeding cable to receive the electric signal, the feeding portion at least having a first side and a second side;
a first radiating portion, coupled to the feeding portion, the first radiating portion at least has a third side, the third side being connected to the first side of the feeding portion, the first side, the third side, and the signal ground portion defining a first slot; and
a second radiating portion, coupled to the feeding portion, the second radiating portion at least has a fourth side, the fourth side of the second radiating portion and the signal ground portion defining a second slot therebetween;
wherein the spacing between the third side of the first radiating portion and a fifth side of the signal ground portion in the first slot is not less than a first distance while the spacing between the fourth side of the second radiating portion and a sixth side of the signal ground portion in the second slot is not less than a second distance so that voltage standing wave ratio (VSWR) of the wideband monopole antenna within a frequency band is less than a first threshold.

8. The electronic device according to claim 7, wherein at least a portion of the third side is parallel to the fifth side and at least a portion of the fourth side is parallel to the sixth side.

9. The electronic device according to claim 7, wherein the first radiating portion extends outwardly from the feeding portion and is gradually enlarged.

10. The wideband monopole antenna according to claim 7, wherein the signal ground portion further comprises an impedance matching structure, the impedance matching structure being connected to the fifth side and at least having a seventh side being in parallel to the sixth side, the wideband monopole antenna being disposed between the sixth side and the seventh side.

11. The wideband monopole antenna according to claim 7, wherein the signal ground portion is used for transmitting a data signal, the wideband monopole antenna at least having a first current path and a second current path, the first current path passing through the feeding portion and the first radiating portion while the second current path passing through the feeding portion and the second radiating portion to have the wideband monopole antenna emitting the data signal through at least the first current path or the second current path.

12. The wideband monopole antenna according to claim 11, wherein the length of the first current path is less than the length of the second current path.
